(19) United States
(12) Patent Application Publication
(10) Pub. No.: US 2023/0299364 A1
(43) Pub. Date: Sep. 21, 2023

(54) ALL-SOLID-STATE BATTERY

(71) Applicant: SAMSUNG ELECTRO-MECHANICS CO., LTD., Suwon-si, Gyeonggi-do (KR)

(72) Inventors: Jong-Min Kim, Suwon-si, Gyeonggi-do (KR); Eun-Hyuk Kim, Suwon-si, Gyeonggi-do (KR); Min-Goo Kang, Suwon-si, Gyeonggi-do (KR); Won-Seh Lee, Suwon-si, Gyeonggi-do (KR); Jeong-Wook Kim, Suwon-si, Gyeonggi-do (KR)

(73) Assignee: SAMSUNG ELECTRO-MECHANICS CO., LTD., Suwon-si, Gyeonggi-do (KR)

(21) Appl. No.: 18/021,027

(22) PCT Filed: Nov. 8, 2021
(86) PCT No.: PCT/KR2021/016102

§ 371 Date: Feb. 13, 2023

(30) Foreign Application Priority Data
Dec. 31, 2020 (KR) 10-2020-0189693

(51) Int. Cl. H01M 10/0587; H01M 10/052; H01M 50/559; H01M 50/107; H01M 50/586; H01M 50/548; H01M 50/593

(52) U.S. Cl. CPC H01M 10/0587; H01M 10/052; H01M 50/559; H01M 50/107; H01M 50/586; H01M 50/548; H01M 50/593

(57) ABSTRACT

An all-solid-state battery includes a electrode assembly including a laminate comprising a solid electrolyte layer, and a negative electrode layer and a positive electrode layer stacked with the solid electrolyte layer interposed therebetween, and an insulating member, the laminate being wound around the insulating member in such a manner that one surface of the negative electrode layer and/or the positive electrode layer is parallel to a central axis of the insulating member in a stacking direction thereof, a negative terminal connected to the negative electrode layer, and a positive terminal connected to the positive electrode layer. When a direction of the central axis of the insulating member is a third direction, the negative terminal is disposed on one surface of the electrode assembly in the third direction, and the positive terminal is disposed on the other surface of the electrode assembly in the third direction.

### TECHNICAL FIELD

The present disclosure relates to an all-solid state battery.

### BACKGROUND ART

Recently, devices using electricity as an energy source have been increasing. As devices using electricity such as smartphones, camcorders, notebook PCs, and electric vehicles expand, interest in electrical storage devices using electrochemical devices is increasing. Among various electrochemical devices, lithium secondary batteries that are capable of being charged and discharged, have a high operating voltage, and extremely high energy density, are in the spotlight.

A lithium secondary battery is manufactured by applying a material capable of insertion and desorption of lithium ions to a positive electrode and a negative electrode, injecting a liquid electrolyte between the positive electrode and a negative electrode, and oxidation according to the insertion and desorption of lithium ions in the negative electrode and the positive electrode. Electricity is generated or consumed by the reduction reaction. Such a lithium secondary battery should be basically stable in the operating voltage range of the battery, and should have performance capable of transferring ions at a sufficiently high speed.

When a liquid electrolyte such as a non-aqueous electrolyte is used in such a lithium secondary battery, there is an advantage in that the discharge capacitance and the energy density are high. However, the lithium secondary battery has problems in that it is difficult to implement a high voltage therewith, and there is a high risk of electrolyte leakage, fire, and explosion.

In order to solve the above problem, a secondary battery to which a solid electrolyte is applied instead of a liquid electrolyte has been proposed as an alternative. The solid electrolyte may be divided into a polymer-based solid electrolyte and a ceramic-based solid electrolyte, and thereamong, the ceramic-based solid electrolyte has an advantage of high stability. However, in the case of a ceramic-based solid electrolyte, sintering at a high temperature is required for manufacturing, and there is a limitation in that a large margin must be formed in order to prevent defects due to shrinkage during the sintering process. In particular, in the case of a circular battery, a positive electrode and a negative electrode are generally connected using a via electrode, and in this case, there is a problem in that it is difficult to secure capacitance because there may be a lot of wasted space due to the existence of the via hole.

### DISCLOSURE OF INVENTION

### Technical Problem

This summary is provided to introduce a selection of concepts in simplified form that are further described below in the Detailed Description. This summary is not intended to identify key features or essential features of the claimed subject matter, nor is it intended to be used as an aid in determining the scope of the claimed subject matter.

An aspect of the present disclosure is to provide an all-solid-state battery in which space utilization may increase.

An aspect of the present disclosure is to provide an all-solid-state battery having increased capacitance.

An aspect of the present disclosure is to provide an all-solid-state battery in which loss due to resistance may be reduced.

An aspect of the present disclosure is to provide an all-solid-state battery having improved productivity.

### Solution to Problem

According to an aspect of the present disclosure, an all-solid-state battery includes a electrode assembly including a laminate comprising a solid electrolyte layer, and a negative electrode layer and a positive electrode layer stacked with the solid electrolyte layer interposed therebetween, and an insulating member, the laminate being wound around the insulating member in such a manner that one surface of the negative electrode layer and/or the positive electrode layer is parallel to a central axis of the insulating member in a stacking direction thereof; a negative terminal connected to the negative electrode layer; and a positive terminal connected to the positive electrode layer. When a direction of the central axis of the insulating member is a third direction, the negative terminal is disposed on one surface of the electrode assembly in the third direction, and the positive terminal is disposed on the other surface of the electrode assembly in the third direction.

According to another aspect of the present disclosure, an all-solid-state battery includes an electrode assembly including: a laminate comprising a solid electrolyte layer, and a negative electrode layer and a positive electrode layer stacked with the solid electrolyte layer interposed therebetween, and an insulating member.

The laminate is wound around the insulating member such that a surface of the negative electrode layer or the positive electrode layer in a stacking direction thereof is parallel to a central axis of the insulating member. Further, at least a portion of the negative electrode layer is exposed to one surface of the electrode assembly in a central axis direction of the central axis of the insulating member, and at least a portion of the positive electrode layer is exposed to the other surface, opposite to the one surface of the electrode assembly in the central axis direction.

According to another aspect of the present disclosure, an all-solid-state battery includes an electrode assembly including: a laminate comprising a solid electrolyte layer, and a negative electrode layer and a positive electrode layer stacked with the solid electrolyte layer interposed therebetween, and an insulating member, a negative terminal connected to the negative electrode layer; and a positive terminal connected to the positive electrode layer. The laminate is wound around the insulating member such that a surface of the negative electrode layer or the positive electrode layer in a stacking direction thereof is parallel to a central axis of the insulating member. The negative electrode layer includes a negative electrode current collector, and a negative active material stacked with the negative electrode current collector interposed therebetween. The positive electrode layer includes a positive electrode current collector, and a positive active material stacked with the positive electrode current collector interposed therebetween.

### Advantageous Effects of Invention

As set forth above, according to an embodiment, an all-solid-state battery in which space utilization may increase may be provided.

A capacitance of an all-solid-state battery may be increased.

An all-solid-state battery in which loss due to resistance may be reduced may be provided.

An all-solid-state battery having improved productivity may be provided.

### BRIEF DESCRIPTION OF DRAWINGS

The above and other aspects, features, and advantages of the present inventive concept will be more clearly understood from the following detailed description, taken in conjunction with the accompanying drawings, in which:

FIG. 1 is a perspective view schematically illustrating an all-solid-state battery according to an embodiment of the present disclosure;

FIG. 2 is a cross-sectional view of FIG. 1;

FIG. 3 is a plan view of FIG. 1;

FIG. 4 is a plan view schematically illustrating an all-solid-state battery according to an embodiment of the present disclosure;

FIGS. 5 and 6 are views schematically illustrating a process of manufacturing an all-solid-state battery according to an embodiment of the present disclosure; and

FIG. 7 is an exploded perspective view illustrating an all-solid-state battery of the related art.

### MODE FOR THE INVENTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. The sequences of operations described herein are merely examples, and are not limited to those set forth herein, but may be changed as will be apparent to one of ordinary skill in the art, with the exception of operations necessarily occurring in a certain order. Also, descriptions of functions and constructions that would be well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will fully convey the scope of the disclosure to one of ordinary skill in the art.

Herein, it is noted that use of the term “may” with respect to an embodiment or example, e.g., as to what an embodiment or example may include or implement, means that at least one embodiment or example exists in which such a feature is included or implemented while all examples and examples are not limited thereto.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms such as “above,” “upper.” “below,” and “lower” may be used herein for ease of description to describe one element's relationship to another element as illustrated in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other manners (for example, rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes illustrated in the drawings may occur. Thus, the examples described herein are not limited to the specific shapes illustrated in the drawings, but include changes in shape that occur during manufacturing.

The features of the examples described herein may be combined in various manners as will be apparent after gaining an understanding of the disclosure of this application. Further, although the examples described herein have a variety of configurations, other configurations are possible as will be apparent after gaining an understanding of the disclosure of this application.

The drawings may not be to scale, and the relative sizes, proportions, and depiction of elements in the drawings may be exaggerated for clarity, illustration, and convenience.

In this specification, expressions such as “A and/or B”, “at least one of A and B”, or “one or more of A and B” may include all cases of (1) including at least one A, (2) including at least one B, or (3) including both at least one A and at least one B.

In the drawings, an X direction may be defined as a first direction, an L direction or a length direction, a Y direction may be defined as a second direction, a W direction or a width direction, and a Z direction may be defined as a third direction, a T direction, or a thickness direction.

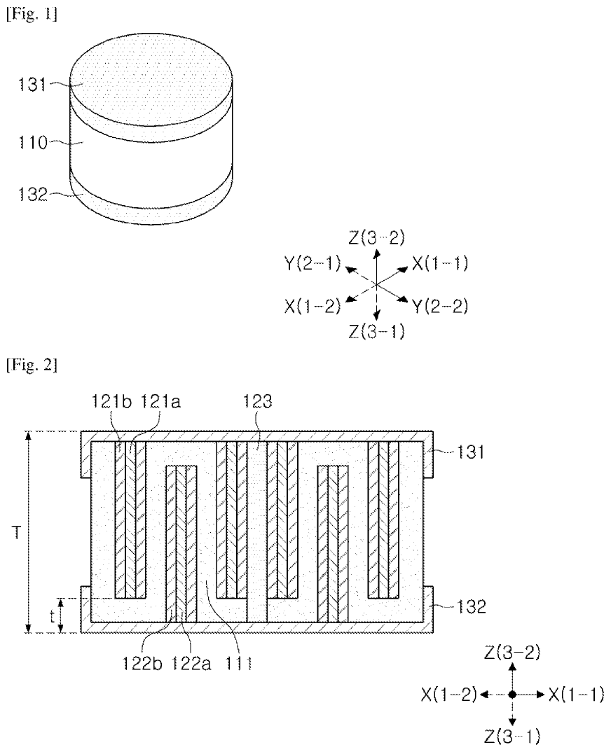

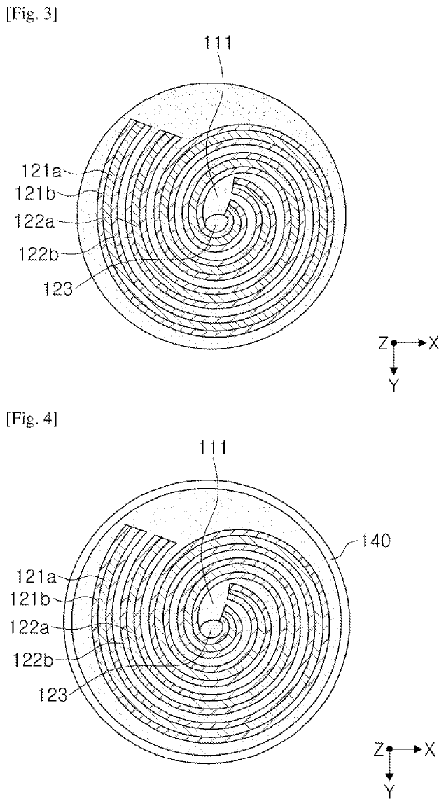

An all-solid-state battery 100 according to an embodiment is provided. FIGS. 1 to 6 are views schematically illustrating the all-solid-state battery 100 according to an embodiment. Referring to FIGS. 1 to 6, the all-solid-state battery 100 according to an embodiment may include an electrode assembly 110 including a laminate comprising a solid electrolyte layer 111 and a negative electrode layer 121 and a positive electrode layer 122 stacked with the solid electrolyte layer 111 interposed therebetween, and an insulating member 123, the electrode assembly 110 being configured in such a manner that the laminate is wound around the insulating member 123 such that one surface of the negative electrode layer 121 and/or the positive electrode layer 122 in a stacking direction is parallel to a central axis of the insulating member 123; a negative terminal 131 connected to the negative electrode layer 121; and a positive terminal 132 connected to the positive electrode layer 122.

In this case, when the central axis direction (or a direction of the central axis) of the insulating member 123 is referred to as a third direction, the negative terminal 131 may be disposed on one surface of the electrode assembly 110 in the third direction, and the positive terminal 132 may be disposed on the other surface of the electrode assembly 110 in the third direction. The all-solid-state battery 100 of this embodiment may have a cylindrical shape because the laminate in which the solid electrolyte layer 111, the negative electrode layer 121, and the positive electrode layer 122 are stacked is wound around the insulating member 123.

In a circular battery of the related art, the negative electrode layer and the positive electrode layer are connected by a via electrode. In the case of an all-solid-state battery of the related art having a quadrangular shape, in which a negative electrode layer and a positive electrode layer are stacked, the negative electrode layer and the positive electrode layer are led out of an electrode assembly, and external terminals may be directly attached to quadrangular shaped lead-out parts. However, in the case of the circular battery, when such a shape is used, there is a problem in that contact with an external terminal is deteriorated, and thus, in general, the negative electrode layer and the positive electrode layer are connected using a via electrode.

FIG. 7 schematically illustrates a circular battery of the related art using a via electrode. Referring to FIG. 7, a negative via electrode 251 connecting negative electrode layers 221 and a positive via electrode 252 connecting positive electrode layers 222 are disposed. In order to prevent a short circuit, via holes through which via electrodes having opposite polarities pass should be secured in the negative electrode layer 221 and the positive electrode layer 222. However, the overlapping area of the negative electrode layer and the positive electrode layer is reduced by the area of the via hole region, and in detail, in the case of a structure in which a plurality of negative electrode layers and positive electrode layers are stacked, there is a problem in that the capacitance is reduced in proportion to the number of via holes.

In the case of the all-solid-state battery 100 according to an embodiment of the present disclosure, a via electrode is not used, and thus a via hole is not disposed. The all-solid-state battery 100 according to an embodiment of the present disclosure has a structure in which a laminate in which the solid electrolyte layer 111, the negative electrode layer 121 and the positive electrode layer 122 are stacked is wound around the insulating member 123. The all-solid-state battery 100 according to an embodiment has a structure in which the negative electrode layer 121 and the positive electrode layer 122 of the laminate are drawn out to the electrode assembly 110 in opposite directions, respectively, and thus the electrode assembly 110 may have a cylindrical shape and the capacitance may also be increased without wasted space due to via holes.

The electrode assembly 110 of the all-solid-state battery 100 according to an embodiment may include a laminate including the solid electrolyte layer 111, the negative electrode layer 121, and the positive electrode layer 122.

In an embodiment of the present disclosure, the solid electrolyte layer 111 according to an embodiment may be at least one selected from the group consisting of Garnet-type, Nasicon-type, LISICON-type, perovskite-type and LiPON-type.

The Garnet-type solid electrolyte may indicate lithium-lanthanum zirconium oxide (LLZO) represented by LiₐLa_{b}Zr_{c}O₁₂, such as Li₇La₃Zr₂O₁₂. The Nasicon-based solid electrolyte may indicate lithium-aluminum-titanium-phosphate (LATP) of Li₁₊ₓAlₓTi₂₋ₓ(PO₄)₃ (0<x<1) in which Ti is introduced into Li₁₊ₓAlₓM₂₋ₓ(PO₄)₃(LAMP) (0<x<2, M=Zr, Ti, Ge)-based compound, and indicate lithium-aluminum-germanium-phosphate (LAGP) represented by Li₁₊ₓAlₓGe₂₋ₓ(PO₄)₃(0<x<1), such as Li_{1.3}Al_{0.3}Ti_{1.7}(PO₄)₃, in which an excess amount of lithium is introduced, and/or lithium-zirconium-phosphate (LZP) of LiZr₂(PO₄)₃.

In addition, the LISICON-based solid electrolyte may indicate solid solution oxide represented by xLi₃AO₄-(1-x)Li₄BO₄ (A: P, As, V or the like, B: Si, Ge, Ti or the like) and including Li₄Zn(GeO₄)₄, Li₁₀GeP₂O₁₂(LGPO), Li_{3.5}Si_{0.5}P_{0.5}O₄, Li_{10.42}Si(Ge)_{1.5}P_{1.5}Cl_{0.08}O_{11.92}, or the like, and solid solution sulfide including Li₂S—P₂S₅, Li₂S—SiS₂, Li₂S—SiS₂—P₂S₅, Li₂S—GeS₂, or the like, represented by Li₄₋ₓM_{1-y}M′_{y}′S₄ (M=Si, Ge and M′=P, Al, Zn, Ga).

The perovskite-based solid electrolyte may refer to lithium-lanthanum-titanate-oxide (lithium lanthanum titanate, LLTO) represented by Li₃ₓLa_{2/3-x□1/3-2x}TiO₃ (0<x<0.16, □ vacancy), such as Li_{1/8}La_{5/8}TiO₃ or the like, and the LiPON-based solid electrolyte may refer to a nitride such as lithium phosphorous-oxynitride of Li_{2.8}PO_{3.3}N_{0.46}, or the like.

The negative electrode layer 121 of the all-solid-state battery 100 according to an embodiment of the present disclosure may include a negative electrode current collector 121a and a negative active material 121b.

The negative electrode layer 121 included in the all-solid-state battery 110 according to an embodiment may include a component known to be usable as a negative active material. As the negative active material 121b, a carbon-based material, silicon, silicon oxide, a silicon-based alloy, a silicon-carbon-based material composite, tin, a tin-based alloy, a tin-carbon composite, a metal oxide, or combinations thereof may be used, and lithium metal and/or a lithium metal alloy may be included.

The lithium metal alloy may include lithium and a metal/metalloid capable of alloying with lithium. For example, the metal/metalloid capable of alloying with lithium may be Si, Sn, Al, Ge, Pb, Bi, Sb, a Si—Y alloy (where Y is an alkali metal, alkaline earth metal, group 13 to 16 element, transition metal, rare earth element, or combination elements thereof, and does not contain Si), a Sn—Y alloy (where Y is an alkali metal, alkaline earth metal, group 13 to 16 element, transition metal, transition metal oxide such as lithium titanium oxide (Li₄Ti₅O₁₂), rare earth element, or combination elements thereof, and does not contain Sn), MnOₓ (0<x<2), and the like. As the element Y, Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Jr, Pd, Pt, Cu, Ag, Au, Zn, Cd, B, Al, Ga, Sn, In, Tl, Ge, P, As, Sb, Bi, S, Se, Te, Po, or combinations thereof may be used.

In addition, the oxide of the metal/metalloid alloyable with lithium may be lithium titanium oxide, vanadium oxide, lithium vanadium oxide, SnO₂, SiOₓ(0<x<2), or the like. For example, the negative active material may include at least one element selected from the group consisting of elements from Groups 13 to 16 of the Periodic Table of Elements. For example, the negative active material may include one or more elements selected from the group consisting of Si, Ge, and Sn.

The carbon-based material may be crystalline carbon, amorphous carbon, or a mixture thereof. The crystalline carbon may be graphite such as amorphous, plate-like, flake-like, spherical or fibrous natural graphite or artificial graphite. In addition, the amorphous carbon may be soft carbon (low temperature calcined carbon) or hard carbon, mesophase pitch carbide, calcined coke, graphene, carbon black, fullerene soot, a carbon nanotube, a carbon fiber, or the like, but is not limited thereto.

The silicon may be selected from the group consisting of Si, SiOₓ (0<x<2, for example, 0.5 to 1.5), Sn, SnO₂, or silicon-containing metal alloys and mixtures thereof. The silicon-containing metal alloy may include, for example, silicon and at least one of Al, Sn, Ag, Fe, Bi, Mg, Zn, in, Ge, Pb and Ti.

A porous body such as a mesh or mesh shape may be used as the negative electrode current collector 121a, and a porous metal plate such as stainless steel, nickel, copper, or aluminum may be used as the negative electrode current collector, but is not limited thereto. In addition, the negative electrode current collector may be coated with an oxidation-resistant metal or alloy film to prevent oxidation.

The negative active material 121b of the all-solid-state battery 100 according to an embodiment may optionally include a conductive agent and a binder. The conductive agent is not particularly limited as long as it has conductivity without causing a chemical change in the all-solid-state battery 100 according to an embodiment. For example, the conductive agent may be graphite, such as natural graphite and artificial graphite; a carbon-based substance such as carbon black, acetylene black, ketjen black, channel black, furnace black, lamp black, and thermal black; a conductive fiber such as carbon fibers and metal fibers; carbon fluoride; metal powder such as aluminum and nickel powder; conductive whisker such as zinc oxide and potassium titanate; conductive metal oxide such as titanium oxide; a conductive material such as polyphenylene derivatives.

The binder may be used to improve bonding strength between the active material and the conductive agent or the like. The binder may be polyvinylidene fluoride, polyvinyl alcohol, carboxymethyl cellulose (CMC), starch, hydroxypropyl cellulose, regenerated cellulose, polyvinyl pyrrolidone, polytetrafluoroethylene, polyethylene, polypropylene, ethylene-propylene-diene terpolymer (EPDM), sulfonated EPDM, styrene butadiene rubber, fluororubber, and various copolymers, but is not limited thereto.

The negative electrode layer 121 applied to the all-solid-state battery 100 according to an embodiment may be prepared by directly coating and drying the composition including the negative active material on the negative electrode current collector including a metal such as copper, but the preparing method is not limited thereto.

In an example of the present disclosure, at least a portion of the negative electrode layer 121 of the all-solid-state battery 100 according to an embodiment may be led out to one surface of the electrode assembly 110 in the third direction. Referring to FIG. 2, the negative electrode layer 121 of the all-solid-state battery 100 according to this example may be led out on one surface of the electrode assembly 110 in the third direction, in more detail, in the 3-2 direction. In the all-solid-state battery 100 according to an embodiment, the negative electrode layer 121 is directly led out to the electrode assembly 110 in the 3-2 direction thereof as described above, and may thus be connected to the negative terminal 131 without a separate via electrode, thereby obtaining a higher capacitance than that of a related art battery.

The positive electrode layer 122 of the all-solid-state battery 100 according to an embodiment may include a positive electrode current collector and a positive active material.

In an example of the present disclosure, the positive active material included in the positive electrode layer 122 is not particularly limited as long as it may secure sufficient capacitance. For example, the positive active material may include at least one selected from the group consisting of lithium cobalt oxide, lithium nickel cobalt manganese oxide, lithium nickel cobalt aluminum oxide, lithium iron phosphorus oxide, and lithium manganese oxide, but is not necessarily limited thereto. Any positive active material available in the art may be used.

The positive active material may be, for example, a compound represented by the following formula: LiₐA_{1-b}M_{b}D₂ (where 0.90≤a≤1.8, 0≤b≤0.5); LiₐE_{1-b}M_{b}O_{2-c}D_{c} (where 0.90≤a≤0.8, 0≤b≤0.5, 0≤c≤0.05); LiE_{2-b}M_{b}O_{4-c}D_{c} (where 0≤b≤0.5, 0≤c≤0.05); LiaNi_{1-b-c}Co_{b}M_{c}D_{α} (where 0.90≤a≤1.8, 0≤b≤0.5, 0≤c≤0.05, 0<α<2); LiₐN_{1-b-c}Co_{b}M_{c}O_{2-α}X_{α} (where 0.90≤a≤1.8, 0≤b≤0.5, 0≤c≤0.05, 0<α<2); LiₐNi_{1-b-c}Co_{b}M_{c}O_{2-α}X₂ (where 0.90≤a≤1.8, 0≤b≤0.5, 0≤c≤0.05, 0<a<2); LiₐN_{1-b-c}Mn_{c}D_{α} (where 0.90≤a≤1.8, 0≤b≤0.5, 0≤c≤0.05, 0<α≤2); LiₐNi_{1-b-c}Mn_{b}M_{c}O_{2-α}X₂ (where 0.90≤a≤1.8, 0≤b≤0.5, 0≤c≤0.05, 0≤c≤2); LiₐNi_{1-b-c}Mn_{b}M_{c}O_{2-α}X₂ (where 0.90≤a≤1.8, 0≤b≤0.5, 0≤c≤0.05, 0<α<2); LiₐNi_{b}E_{c}G_{d}O₂ (where 0.90≤a≤1.8, 0≤b≤0.9, 0≤c≤0.5, 0.001≤d≤0.1); Li₃Ni_{b}Co_{c}Mn_{d}G_{c}O₂ (where 0.90≤a≤1.8, 0≤b≤0.9, 0≤c≤0.5, 0≤d≤0.5, 0.001≤e≤0.1); LiₐNiG_{b}O₂ (where 0.90≤a≤1.8, 0.001≤b≤0.1); LiₐCoG_{b}O₂ (where 0.90≤a≤1.8, 0.001≤b≤0.1); LiₐMnG_{b}O₂ (where 0.90≤a≤1.8, 0.00≤b≤0.1); LiₐMn₂G_{b}O₄ (where 0.90≤a≤1.8, 0.001≤b≤0.1); QO₂; QS₂; LiQS₂; V₂O₅; LiV₂O₂; LiRO₂; LiNiVO₄; Li_{(3-f)}(PO₄)₃ (0≤f≤2); Li_{(3-f)}Fe₂(PO₄)₃(where 0≤f≤2); and LiFePO₄. In the above formula, A is Ni. Co, or Mn; M is Al, Ni, Co, Mn, Cr, Fe, Mg, Sr, V, or a rare-earth element; D is O, F, S, or P; E is Co or Mn; X is F, S, or P; G is Al, Cr, Mn, Fe, Mg, La, Ce, Sr, or V; Q is Ti, Mo or Mn; R is Cr, V, Fe. Sc, or Y; J is V, Cr, Mn, Co, Ni, or Cu.

The positive active material may also be LiCoO₂, LiMnₓO₂ₓ, (where x=1 or 2), LiNi₁₋ₓMnₓO₂ₓ (where 0<x<1), LiNi_{1-x-y}CoₓMn_{y}O₂ (where 0≤x≤0.5, 0≤y≤0.5), LiFePO₄, TiS₂, FeS₂, TiS₃, or FeS₃, but is not limited thereto.

The positive electrode current collector of the all-solid-state battery 100 according to an embodiment may have the same configuration as the negative electrode current collector. The positive electrode current collector may use, for example, a porous body such as a mesh or mesh shape, and may use a porous metal plate such as stainless steel, copper, nickel, or aluminum, but is not limited thereto. In addition, the positive electrode current collector may be coated with an oxidation-resistant metal or alloy film to prevent oxidation.

The positive electrode layer 122 may be manufactured according to almost the same method as the above-described negative electrode manufacturing process, except for using the positive active material instead of the negative active material.

In an example of the present disclosure, at least a portion of the positive electrode layer 122 of the all-solid-state battery 100 according to an embodiment may be led out to one surface of the electrode assembly 110 in the third direction. Referring to FIG. 2, the positive electrode layer 122 of the all-solid-state battery 100 according to this example may be led out on one surface of the electrode assembly 110 in the third direction, in more detail, in the 3-1 direction. In the all-solid-state battery 100 according to an embodiment, the positive electrode layer 122 is directly drawn out in the 3-1 direction of the electrode assembly 110 as described above, and may thus be connected to the positive terminal 132 without a separate via electrode, thereby obtaining a higher capacitance than that in a related art battery.

In the electrode assembly 110 of the all-solid-state battery 100 according to an embodiment, the aforementioned laminate may be wound around the insulating member 123. The insulating member 123 may have a columnar shape with a third direction as a central axis. The insulating member 123 may have, for example, a cylindrical shape, but the shape is not limited thereto. The electrode assembly 110 of the all-solid-state battery 100 according to an embodiment is formed by winding the laminate around the insulating member 123 as a central axis without requiring a separate via hole forming process or the like. Therefore, the productivity of the solid battery 100 may be improved by simplifying a production process.

The insulating member 123 may include a ceramic material, for example, alumina (Al₂O₃), aluminum nitride (AlN), beryllium oxide (BeO), boron nitride (BN), silicon (Si), silicon carbide (SiC), silica (SiO), silicon nitride (Si₃N₄), gallium arsenide (GaAs), gallium nitride (GaN), barium titanate (BaTiO₃), zirconium dioxide (ZrO₃), mixtures thereof, oxides and/or nitrides of these materials, or any other suitable ceramic material, but the material thereof is not limited thereto. In addition, the insulating member 123 may optionally include the aforementioned solid electrolyte, and may include one or more solid electrolytes, but the configuration is not limited thereto.

In an embodiment, in the laminate of the all-solid-state battery 100 according to an embodiment, the negative electrode layer 121 may be disposed in contact with the insulating member 123. In this case, the negative electrode layer 121 may be disposed on an innermost side of the electrode assembly 110. In the case of the electrode assembly 110 of the all-solid-state battery 100 according to an embodiment of the present disclosure, since the laminate is wound around the insulating member 123 as a central axis, electrical isolation may be provided even when the negative electrode layer 121 is disposed on the innermost side, and thus, short circuits may not occur.

In another embodiment of the present disclosure, in the laminate of the all-solid-state battery 100 according to an embodiment, the positive electrode layer 122 may be disposed in contact with the insulating member 123. In this case, the positive electrode layer 122 may be disposed on an innermost side of the electrode assembly 110. In the electrode assembly 110 of the all-solid-state battery 100 according to an embodiment, since the laminate is wound around the insulating member 123 as a central axis, a short circuit may not occur even when the positive electrode layer 122 is disposed on the innermost side.

In another embodiment of the present disclosure, in the laminate of the all-solid-state battery 100 according to an embodiment, the solid electrolyte layer 111 may be disposed to be in contact with the insulating member 123. In this case, the solid electrolyte layer 111 may be disposed on the innermost side of the electrode assembly 110. When the solid electrolyte layer 111 of this embodiment includes the solid electrolyte of the above-described component, and the insulating member 123 includes the above-described ceramic component, the solid electrolyte layer Ill and the insulating member 123 may have a similar sintering shrinkage behavior, and thus, the bonding force between the solid electrolyte layer 111 and the insulating member 123 may be improved.

In an example of the present disclosure, the solid electrolyte layer 111 may be disposed on an outermost portion of the electrode assembly 110 of the all-solid-state battery 100 according to an embodiment. The all-solid-state battery 100 according to an embodiment may include an electrode assembly 110 in which a laminate including a solid electrolyte layer 111, a negative electrode layer 121 and a positive electrode layer 122 stacked on each other is wound around an insulating member 123 as a center. In this case, for the electrical stability of the all-solid-state battery 100, the negative electrode layer 121 or the positive electrode layer 122 should not be exposed to the outside of the laminate. When the solid electrolyte layer 111 is disposed on the outermost side of the electrode assembly 110 as in the above example, the negative electrode layer 121 or the positive electrode layer 122 may not be naturally exposed to the outside thereof, and the solid electrolyte layer 111 may also function to protect the internal structure of the electrode assembly 110 through sintering.

In an example, the shape of the electrode assembly 110 of the all-solid-state battery 100 according to an embodiment in the third direction may be circular. Since the electrode assembly 110 is formed by winding the laminate around the insulating member 123 as a central axis to be described later, the electrode assembly 110 may have a circular shape in the third direction. The circular shape does not mean only a perfect circle in a strict sense, and may refer to various shapes that may be recognized as a circle including some curved portions present due to errors in the manufacturing process or an oval.

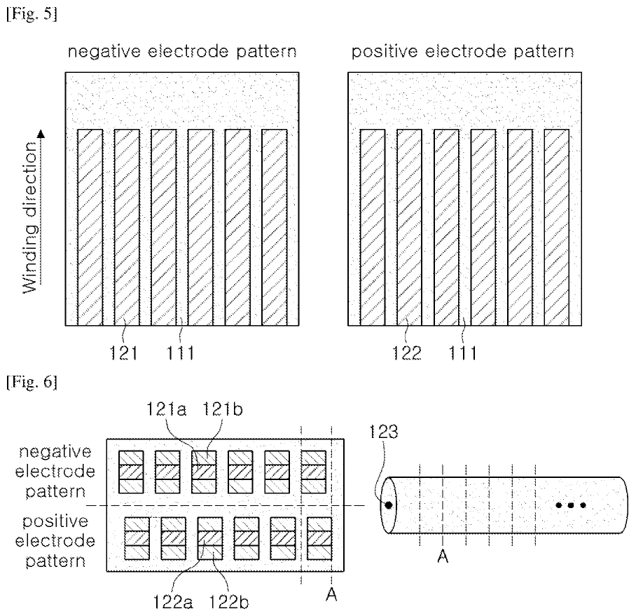

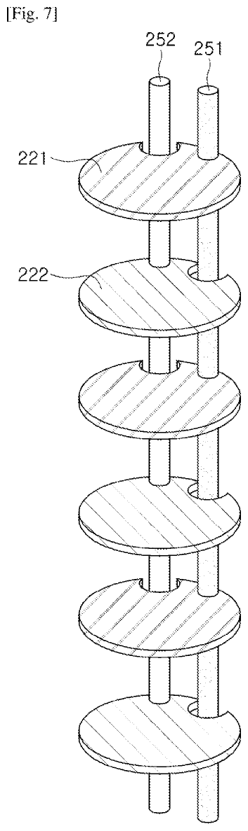

FIGS. 5 and 6 are views schematically illustrating a part of the manufacturing process of the all-solid-state battery 100 according to an embodiment. Referring to FIGS. 5 and 6, in the laminate of the all-solid-state battery 100 according to an embodiment, a plurality of solid electrolyte layer 111 sheets are prepared by applying and drying a solid electrolyte on a carrier film. Thereafter, a negative electrode pattern and a positive electrode pattern for forming the negative electrode layer 121 and the positive electrode layer 122 may be printed on the solid electrolyte layer 111 and stacked, thereby forming the laminate. The laminate may be wound around the insulating member 123 as the center thereof to form a cylindrically wound stacked body. Thereafter, the laminate wound on the insulating member 123 may be cut at regular intervals to form an electrode assembly 110 in which the negative electrode layer 121 is exposed through one cut surface and the positive electrode layer 122 is exposed through the other cut surface.

A negative terminal 131 and a positive terminal 132 may be disposed on both surfaces of the electrode assembly 110 of the all-solid-state battery 100 according to an embodiment in the third direction, respectively. In detail, the negative terminal 131 may be disposed in the 3-2 direction of the electrode assembly 110, and the positive terminal 132 may be disposed in the 3-1 direction of the electrode assembly 110, respectively.

The negative terminal 131 and the positive terminal 132 are formed by, for example, applying a terminal electrode paste including a conductive metal to both surfaces of the electrode assembly 110 in the third direction, respectively, or by transferring a dried film obtained by drying the conductive paste onto the electrode assembly 110 and then sintering the same, but the method is not limited thereto. The conductive metal may be at least one conductive metal among, for example, copper (Cu), nickel (Ni), tin (Sn), palladium (Pd), platinum (Pt), gold (Au), silver (Ag), tungsten (W), titanium (Ti), lead (Pb), and alloys thereof, but is not limited thereto.

In an example of the present disclosure, a surface of the negative electrode layer 121 connected to the negative terminal 131 may have a spiral shape. In the present specification, the “spiral” of the surface of a member is expressed as a spiral or a helix, and it may mean that as the number of times wound around the insulating member 123 of the member increases, a shortest distance from the insulating member 123 to the member increases. In the electrode assembly 110 according to an embodiment, the laminate may be wound around the insulating member 123 as an axis. Accordingly, as the number of times the laminate is wound increases, a shortest distance from the insulating member 123 to an outermost point of the laminate may be increased. The negative electrode layer 121 according to an embodiment may be led out in the 3-2 direction of the electrode assembly 110, and the negative electrode layer 121 led out in the 3-2 direction of the electrode assembly 110 may be connected to the negative terminal 131.

The shape of the surface of the negative electrode layer 121 drawn out in the 3-2 direction of the electrode assembly 110 may be a spiral shape, and the shape of the surface of the negative electrode layer 121 connected to the negative terminal 131 may have a spiral shape. In the all-solid-state battery 100 according to an embodiment, one surface of the negative electrode layer 121 of the laminate wound around the insulating member 123 as a central axis may be led out in the 3-2 direction of the electrode assembly 110, and the negative electrode layer 121 drawn out in the 3-2 direction of the electrode assembly 110 may be connected to the negative terminal 131. In the all-solid-state battery 100 according to an embodiment, the surface drawn out to one surface of the electrode assembly 110 in the 3-2 direction is disposed to be connected to the negative terminal 131, thereby increasing a connection area with the negative terminal 131 as compared to a case in which a via electrode is used, and thus, reducing loss due to resistance.

In an example of the present disclosure, the surface where the positive electrode layer 122 is connected to the positive terminal 132 may have a spiral shape. The positive electrode layer 122 according to an embodiment may be led out in the 3-1 direction of the electrode assembly 110, and the positive electrode layer 122 drawn out in the 3-1 direction of the electrode assembly 110 may be connected to the positive terminal 132. The shape of the surface of the positive electrode layer 122 drawn out in the 3-1 direction of the electrode assembly 110 may be a spiral shape, and the shape of the surface of the positive electrode layer 122 connected to the positive terminal 132 may be a spiral shape. In the all-solid-state battery 100 according to an embodiment, the surface drawn out to one surface of the electrode assembly 110 in the 3-1 direction is disposed to be connected to the positive terminal 132, thereby increasing a connection area with the positive terminal 132 as compared with the case of using a via electrode or the like, and thus, reducing loss due to resistance.

In an example, in the all-solid-state battery 100 according to an embodiment, when an average distance between the interface of the electrode assembly 110 in contact with the negative terminal 131 to the interface of the electrode assembly 110 in contact with the positive terminal 132 is T, and an average distance between the negative electrode layer 121 and the positive terminal 132 or between the positive electrode layer 122 and the negative terminal 131 is t; the percentage ((t/T)×100) of t to T may be in the range of 1% or more and/or 30% or less. In the present specification, “distance” may mean the shortest vertical distance from, one member to another member, and “average distance” may mean an arithmetic average of distances measured at the positions of the negative electrode layer 121 or the positive electrode layer 122 at each of five left and right locations thereof from the insulating member 123, with respect to a cross-sectional surface cut in a direction parallel to the Z axis while passing through the center of the insulating member 123 of the solid-state battery 100. Referring to FIG. 2, the t may indicate an average margin of the negative electrode layer 121 or the positive electrode layer 122 in the third direction, and the T may indicate the average thickness of the electrode assembly 110 in the third direction. In the all-solid-state battery 100 according to an embodiment, the capacitance may be further increased by adjusting the t to satisfy the above range.

In an example of the present disclosure, a portion of the negative terminal 131 of the all-solid-state battery 100 according to an embodiment is disposed on one surface of the electrode assembly 110 in the third direction, and the rest part of the negative terminal 131 may extend on a surface of the electrode assembly 110 perpendicular to the third direction. In addition, a portion of the positive terminal 132 may be disposed on the other surface of the electrode assembly 110 in the third direction, and the remaining portion of the positive terminal 132 may be extended on the surface of the electrode assembly 110 perpendicular to the third direction. In this case, the negative terminal 131 and the positive terminal 132 may be disposed to be spaced apart from each other on the surface of the electrode assembly 110 perpendicular to the third direction. The extended portion may function as a so-called band portion, and may function to prevent moisture penetration in the all-solid-state battery 100 according to an embodiment.

In an example, the all-solid-state battery 100 according to an embodiment may further include a plating layer (not illustrated) disposed on the negative terminal 131 and the positive terminal 132, respectively. The plating layer may include at least one selected from the group consisting of copper (Cu), nickel (Ni), tin (Sn), palladium (Pd), platinum (Pt), gold (Au), silver (Ag), tungsten (W), titanium (Ti), lead (Pb) and alloys thereof, but is not limited thereto. The plating layer may be formed of a single layer or a plurality of layers, and may be formed by sputtering or electrolytic plating (Electric Deposition), but the formation method is not limited thereto.

In an embodiment, the all-solid-state battery 100 of the present disclosure may further include a case 140 disposed to surround the electrode assembly 110 in the first direction and the second direction. The case may function to prevent external contamination or impact. The material of the case is not particularly limited, and may include, for example, a ceramic component such as that of the aforementioned insulating member 123 or a polymer such as an epoxy resin, but the material is not limited thereto.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed to have a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

1. An all-solid-state battery comprising:
an electrode assembly including a laminate comprising a solid electrolyte layer, and a negative electrode layer and a positive electrode layer stacked with the solid electrolyte layer interposed therebetween, and an insulating member, the laminate being wound around the insulating member in such a manner that one surface of the negative electrode layer or the positive electrode layer is parallel to a central axis of the insulating member in a stacking direction thereof;
a negative terminal connected to the negative electrode layer; and
a positive terminal connected to the positive electrode layer,
wherein the negative terminal is disposed on one surface of the electrode assembly in a central axis direction of the central axis of the insulating member, and the positive terminal is disposed on the other surface of the electrode assembly in the central axis direction.

2. The all-solid-state battery of claim 1, wherein a shape of the electrode assembly in the central axis direction is circular.

3. The all-solid-state battery of claim 1, wherein at least a portion of the negative electrode layer is led out to the one surface of the electrode assembly in the central axis direction, and
at least a portion of the positive electrode layer is led out to the other surface of the electrode assembly in the central axis direction.

4. The all-solid-state battery of claim 1, wherein the negative electrode layer includes a negative electrode current collector, and a negative active material stacked with the negative electrode current collector interposed therebetween, and
the positive electrode layer includes a positive electrode current collector, and a positive active material stacked with the positive electrode current collector interposed therebetween.

5. The all-solid-state battery of claim 1, wherein the laminate is disposed in such a manner that the negative electrode layer is in contact with the insulating member.

6. The all-solid-state battery of claim 1, wherein the laminate is disposed in such a manner that the positive electrode layer is in contact with the insulating member.

7. The all-solid-state battery of claim 1, wherein the laminate is disposed in such a manner that the solid electrolyte layer is in contact with the insulating member.

8. The all-solid-state battery of claim 1, wherein the electrode assembly is provided with the solid electrolyte layer disposed on an outermost portion thereof.

9. The all-solid-state battery of claim 1, wherein a surface to which the negative electrode layer and the negative terminal are connected has a spiral shape.

10. The all-solid-state battery of claim 1, wherein a surface to which the positive electrode layer and the positive terminal are connected has a spiral shape.

11. The all-solid-state battery of claim 1, wherein a percentage of an average distance t between the negative electrode layer and the positive terminal or between the positive electrode layer and the negative terminal, with respect to an average distance T between an interfacial surface of the electrode assembly in contact with the negative terminal and an interfacial surface of the electrode assembly in contact with the positive terminal, is in a range of 1% or more and 30% or less.

12. The all-solid-state battery of claim 1, wherein a portion of the negative terminal is disposed on the one surface of the electrode assembly in the central axis direction, and the other portion of the negative terminal is disposed extending on a surface of the electrode assembly, perpendicular to the central axis direction, and
a portion of the positive terminal is disposed on the other surface of the electrode assembly in the central axis direction, and the other portion of the negative terminal is disposed extending on a surface of the electrode assembly perpendicular to the central axis direction.

13. The all-solid-state battery of claim 1, wherein the insulating member includes an oxide, a nitride, or a compound thereof of a metal and/or non-metal compound.

14. The all-solid-state battery of claim 1, further comprising:
a case disposed to surround the electrode assembly in a first direction and a second direction, wherein a direction perpendicular to the central axis direction is defined as the first direction and a direction perpendicular to the central axis direction and the first direction is defined as the second direction.

15. An all-solid-state battery comprising:
an electrode assembly including:
a laminate comprising a solid electrolyte layer, and a negative electrode layer and a positive electrode layer stacked with the solid electrolyte layer interposed therebetween, and
an insulating member,
wherein the laminate is wound around the insulating member such that a surface of the negative electrode layer or the positive electrode layer in a stacking direction thereof is parallel to a central axis of the insulating member, and
at least a portion of the negative electrode layer is exposed to one surface of the electrode assembly in a central axis direction of the central axis of the insulating member, and at least a portion of the positive electrode layer is exposed to the other surface, opposite to the one surface, of the electrode assembly in the central axis direction.

16. The all-solid-state battery of claim 15, wherein a shape of the electrode assembly in the central axis direction is circular.

17. The all-solid-state battery of claim 15, wherein the negative electrode layer includes a negative electrode current collector, and a negative active material stacked with the negative electrode current collector interposed therebetween, and
the positive electrode layer includes a positive electrode current collector, and a positive active material stacked with the positive electrode current collector interposed therebetween.

18. The all-solid-state battery of claim 15, wherein the laminate is disposed in such a manner that the negative electrode layer is in contact with the insulating member.

19. The all-solid-state battery of claim 15, wherein the laminate is disposed in such a manner that the positive electrode layer is in contact with the insulating member.

20. The all-solid-state battery of claim 15, wherein the laminate is disposed in such a manner that the solid electrolyte layer is in contact with the insulating member.

21. The all-solid-state battery of claim 15, wherein the electrode assembly is provided with the solid electrolyte layer disposed on an outermost portion thereof.

22. The all-solid-state battery of claim 15, further comprising a negative terminal connected to the negative electrode layer, wherein a surface to which the negative electrode layer and the negative terminal are connected has a spiral shape.

23. The all-solid-state battery of claim 22, further comprising a positive terminal connected to the positive electrode layer, wherein a surface to which the positive electrode layer and the positive terminal are connected has a spiral shape.

24. The all-solid-state battery of claim 23, wherein a percentage of an average distance t between the negative electrode layer and the positive terminal or between the positive electrode layer and the negative terminal, with respect to an average distance T between an interfacial surface of the electrode assembly in contact with the negative terminal and an interfacial surface of the electrode assembly in contact with the positive terminal, is in a range of 1% or more and 30% or less.

25. The all-solid-state battery of claim 23, wherein a portion of the negative terminal is disposed on the one surface of the electrode assembly in the central axis direction, and the other portion of the negative terminal is disposed extending on a surface of the electrode assembly, perpendicular to the central axis direction, and
a portion of the positive terminal is disposed on the other surface of the electrode assembly in the central axis direction, and the other portion of the negative terminal is disposed extending on a surface of the electrode assembly perpendicular to the central axis direction.

26. The all-solid-state battery of claim 15, wherein the insulating member includes an oxide, a nitride, or a compound thereof of a metal and/or non-metal compound.

27. An all-solid-state battery comprising:
an electrode assembly including:
a laminate comprising a solid electrolyte layer, and a negative electrode layer and a positive electrode layer stacked with the solid electrolyte layer interposed therebetween, and
an insulating member, wherein the laminate is wound around the insulating member such that a surface of the negative electrode layer or the positive electrode layer in a stacking direction thereof is parallel to a central axis of the insulating member,
a negative terminal connected to the negative electrode layer; and
a positive terminal connected to the positive electrode layer,
wherein the negative electrode layer includes a negative electrode current collector, and a negative active material stacked with the negative electrode current collector interposed therebetween, and the positive electrode layer includes a positive electrode current collector, and a positive active material stacked with the positive electrode current collector interposed therebetween.

28. The all-solid-state battery of claim 27, wherein a shape of the electrode assembly in a central axis direction of the central axis of the insulating member is circular.

29. The all-solid-state battery of claim 27, wherein at least a portion of the negative electrode layer is led out to one surface of the electrode assembly in a central axis direction of the central axis of the insulating member, and
at least a portion of the positive electrode layer is led out to the other surface of the electrode assembly in the central axis direction.

30. The all-solid-state battery of claim 27, wherein the laminate is disposed in such a manner that the negative electrode layer is in contact with the insulating member.

31. The all-solid-state battery of claim 27, wherein the laminate is disposed in such a manner that the positive electrode layer is in contact with the insulating member.

32. The all-solid-state battery of claim 27, wherein the laminate is disposed in such a manner that the solid electrolyte layer is in contact with the insulating member.

33. The all-solid-state battery of claim 27, wherein the electrode assembly is provided with the solid electrolyte layer disposed on an outermost portion thereof.

34. The all-solid-state battery of claim 27, wherein a surface to which the negative electrode layer and the negative terminal are connected has a spiral shape.

35. The all-solid-state battery of claim 27, wherein a surface to which the positive electrode layer and the positive terminal are connected has a spiral shape.
